(19) United States
(12) Patent Application Publication
(10) Pub. No.: US 2004/0264564 A1
(43) Pub. Date: Dec. 30, 2004

(54) System and method for efficiently using video encoding resources

(76) Inventor: Michael D. Senger, Endicott, NY (US)

Correspondence Address: McGuireWoods LLP, Tysons Corner, Suite 1800, 1750 Tysons Boulevard, McLean, VA, 22102-4215, US

(21) Appl. No.: 10/603,868

(22) Filed: Jun. 26, 2003

(51) Int. Cl. H04N 7/12

(52) U.S. Cl. 375/240.01

(57) ABSTRACT

A system and method efficiently use available video encoding resources when automatic machine recognition (e.g., barcode reading and optical character recognition) does not successfully resolve information needed for handling articles. The system includes at least one programmable processor operatively coupled to an imaging device (e.g., a camera or optical sensor) that is capable of producing an electronic image of an article and to one or more video coding stations. If the imaging device does not resolve information needed for handling an article, it is determined whether an estimated time for video coding exceeds a determined threshold. If the estimated time for video coding does not exceed the determined threshold, or if the video coding station is not busy, then image data for the unresolved information is sent to the video coding station for review and manual entry by an operator.

### BACKGROUND OF THE INVENTION

1. Field of the Invention

This invention generally relates to systems for sorting articles according to information (such as addresses or barcodes) on the articles, and more particularly, to systems and methods for efficiently using available video encoding resources when automatic machine recognition (e.g., barcode reading and optical character recognition) does not successfully resolve information needed for sorting articles.

2. Background Description

Many manufacturing and service industries rely on the ability to rapidly sort articles according to information displayed on such articles. Particularly demanding applications include mail or package sorting and the processing of financial documents such as checks, where both the number of articles and the number of potential categories into which the articles must be sorted are very large.

Machines used to automate sorting processes are typically large and complex. Locations receiving each sorted category of article (e.g. each intermediate or final destination) must be of substantial size to receive the articles. Concomitantly, the transport path is typically long enough to accommodate the number of receiving stations corresponding to the respective sort categories. To accommodate large volumes of articles and very high transport speeds, components such as optical character recognition (OCR) and bar code reading (BCR) systems must function accurately at very high speed to achieve the desired sorting.

Unfortunately, for a variety of reasons, OCR/BCR systems occasionally fail to resolve information (such as address information) required for proper sorting. The failure may be due to component problems such as a faulty bar code reader, due to limitations of an optical character recognition program, or due to undecipherable, incomplete, improperly arranged, concealed or damaged information. When such failures occur, many conventional sorting systems rely on manual coding.

One type of manual coding process involves video coding. Video coding systems display an image of the unresolved information on a video display. An operator views the image and enters the correct address. The image data is typically stored in a buffer until an operator is available or the system times out. Until video coding is completed or times out, corresponding articles may be temporarily held in a storage station, cycled through a transport path or otherwise held in abeyance. By way of example, upon an operator's resolution of address information, the article may be reintroduced into (or proceed through) the transport path for sorting. If the image is unintelligible, an operator may direct the article to be transported to a manual handling and entry station or to a sort bin for unresolved articles. If the image is not reviewed within a determined amount of time, the system may transport the article to a manual handling and entry station or to another station along the transport path (e.g., a sort bin for unresolved articles) for rejection or re-processing.

The foregoing conventional process works reasonably well if the number of articles with unresolved information is manageable for the available video coding operators, and does not consume appreciable system resources. However, serious problems arise if a large number of articles with unresolved information overwhelm the operators or consume appreciable system resources. For example, depending upon the system, a limited number of articles may be held in abeyance pending video coding. Such systems simply cannot efficiently accommodate more than a determined amount of articles for video coding. In systems where articles with unresolved information cycle through the transport path pending video coding, each recycled article prevents a new article from being introduced on the transport path, thereby reducing throughput. Eventually, articles that are recycled or held in abeyance may time-out, requiring re-processing and further reducing efficiency. As conventional systems do not determine whether adequate video coding capacity is available, inefficiencies from assigning an excessive number of articles for video coding are highly probable. This compromises overall efficiency.

The invention is directed to overcoming one or more of the problems as set forth above.

### SUMMARY OF THE INVENTION

In one aspect of the invention, a method for using video encoding resources in an article handling system is provided. The method includes a step of determining whether an estimated time for video coding exceeds a determined threshold, if an imaging device of the article handling system does not resolve information needed for handling an article. If the estimated time for video coding does not exceed the determined threshold, then image data for unresolved information is sent to a video coding station.

In another aspect of the invention, a method for using video encoding resources that employs a wait queue in an article handling system is provided. The method includes a step of determining whether an estimated time for video coding exceeds a determined threshold, if the imaging device does not resolve information needed for handling an article. If the estimated time for video coding does not exceed the determined threshold, then image data for the unresolved information is sent to a wait queue until a determined release event or timeout occurs. If the determined release event occurs, then the image data for the unresolved information is sent from the wait queue to a video coding buffer. If the estimated time for video coding exceeds the determined threshold, then a determination is made whether the video coding station is busy. If the video coding station is not busy, then image data for the unresolved information is sent to the wait queue until a determined release event or timeout occurs. If the determined release event occurs, then image data for the unresolved information is sent from the wait queue to the video coding buffer. If the video coding station is busy, then the image data for the unresolved information is not sent to the video coding buffer.

In a further aspect of the invention, a system for using available video encoding resources for handling articles in an article handling system is provided. The system includes an imaging device for producing image data representative of information on an article. Also included is a video coding station for manually entering unresolved information. The system further includes at least one programmable processor operatively coupled to the imaging device and the video coding station. At least one of the at least one programmable processor is programmed to determine whether an estimated time for video coding exceeds a determined threshold if the imaging device does not resolve information needed for handling an article. Additionally, at least one of the at least one programmable processor is programmed to send image data for the unresolved information to the video coding station if the estimated time for video coding does not exceed the determined threshold.

### BRIEF DESCRIPTION OF THE DRAWINGS

FIG. 1 shows a high-level schematic diagram of an article handling system in accordance with an exemplary implementation of the invention;

FIG. 2 is a flow diagram illustrating steps of a methodology for allocating video coding resources in accordance with an exemplary implementation of the invention; and

FIG. 3 is a flow diagram illustrating steps of a video coding response methodology in accordance with an exemplary implementation of the invention.

### DETAILED DESCRIPTION OF EMBODIMENTS OF THE INVENTION

The invention is directed to an article handling system and method for allocating available video encoding resources when automatic machine recognition (e.g., barcode reading and optical character recognition) does not successfully resolve information needed for handling (e.g., sorting) an article. The invention is readily applicable to article handling systems, such as mail sorting systems, that have at least one station for manually entering unresolved information pertaining to an article. The invention allocates video encoding resources when it is determined that encoding can probably be completed in a timely manner or that video coding stations are not busy. Thus, unresolved articles are less likely to consume valuable system resources, including physical space, for a prolonged period of time when video coding stations are saturated.

### System of the Invention

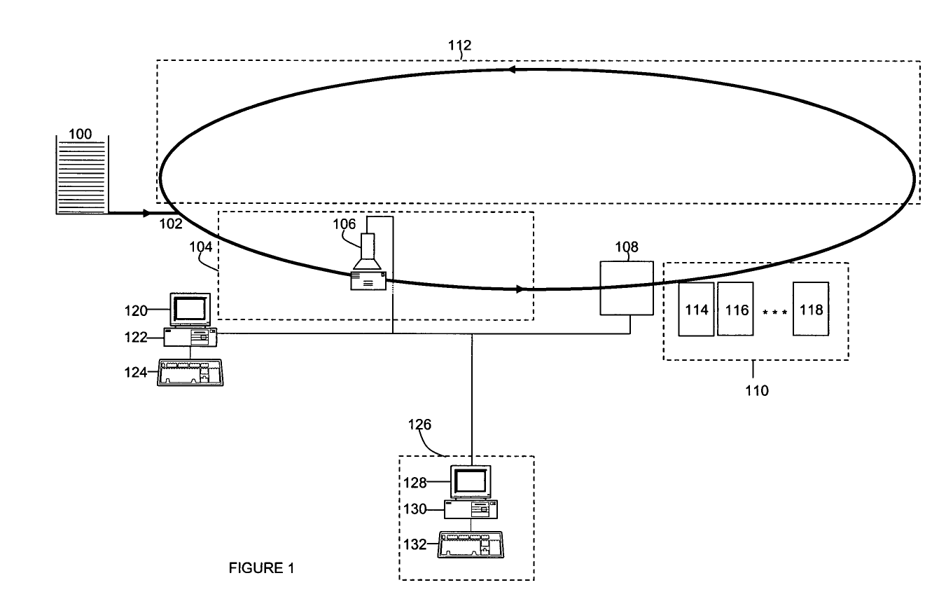

FIG. 1 illustrates an exemplary article sorting system of the type used for processing mail or other types of articles. A feeder 100 feeds articles such as mail, packages and the like (referred to generally as mail pieces or articles) separately to a transport path 102. Transport mechanisms (not shown) such as rollers, belts and conventional conveying devices advance the mail pieces along the transport path. A processing segment 104 of the transport path includes an imaging device 106 such as a camera or optical sensor capable of producing an electronic image of the article. Additional devices, such as printers or coding devices for applying bar codes, may also be included in the processing segment. A router 108 selectively routes the mail pieces to an output segment 110 or a return loop 112. The output segment 110 selectively directs the mail pieces to any of a plurality of sort bins 114-116 corresponding to various sort categories, which may include re-sort and unsorted bins for pieces that were not successfully sorted.

The imaging device 106 and router 108 are, in an exemplary embodiment, operatively coupled to one or more programmable processors 122 for managing operation of the sorting system. The programmable processor 122 may be comprised of a single processing unit or a plurality of processing units. The programmable processor 122 may also be operatively coupled to memory, communications devices, and other circuits and components as known in the art for implementing an article handling system. A display device 120, such as a liquid crystal display (LCD) or cathode ray tube (CRT) monitor, and an input device, such as a keyboard 124, are also operatively coupled to the processor 122.

Still referring to FIG. 1, one or more operator input stations 126 (i.e., video coding stations) are operatively coupled to the sorting system. By way of example, each operator input station may include a computer 130 with a display 128, such as an LCD or CRT monitor, and an input device 132, such as a keyboard. Each such computer may include a buffer or be operatively coupled to a buffer for temporarily storing image data for unresolved articles.

If use of an imaging device 106 fails to resolve information (such as address information) required for proper sorting, an unresolved article may be directed by routing gate 108 to the return loop 112. Image data corresponding to the unresolved information may then be sent to a buffer operatively coupled to an operator input station 122. An operator may then view the image on the operator's display monitor 126 and input the correct information using an input device 128.

In accordance with the invention, an article handling system is equipped with hardware, firmware and/or software for allocating available video encoding resources if it is estimated that an operator should probably be able to input correct information for an unresolved article within a determined amount of time or if it is determined that the video encoding resources are not busy. If the determination is negative, the article will not be recycled through the return loop or otherwise held in abeyance. Rather, the article may be sent to another destination, such as a sort bin for unresolved articles or to a manual handling and coding station.

Software for implementing a system and methodology in accordance with the invention may be stored on a mass storage device such as a hard disk, removable media such as a magnetic disk, memory and/or other computer software storage means operatively coupled to (or forming an integral part of) the mail handling system. The software may include an operating system, one or more application programs, other program modules, and program data. Firmware, programmable read only memory, application specific integrated circuits, field-programmable gate arrays and other manifestations of computer processing instructions may be employed in lieu of or in addition to software without departing from the scope of the invention.

### Methodology of the Invention

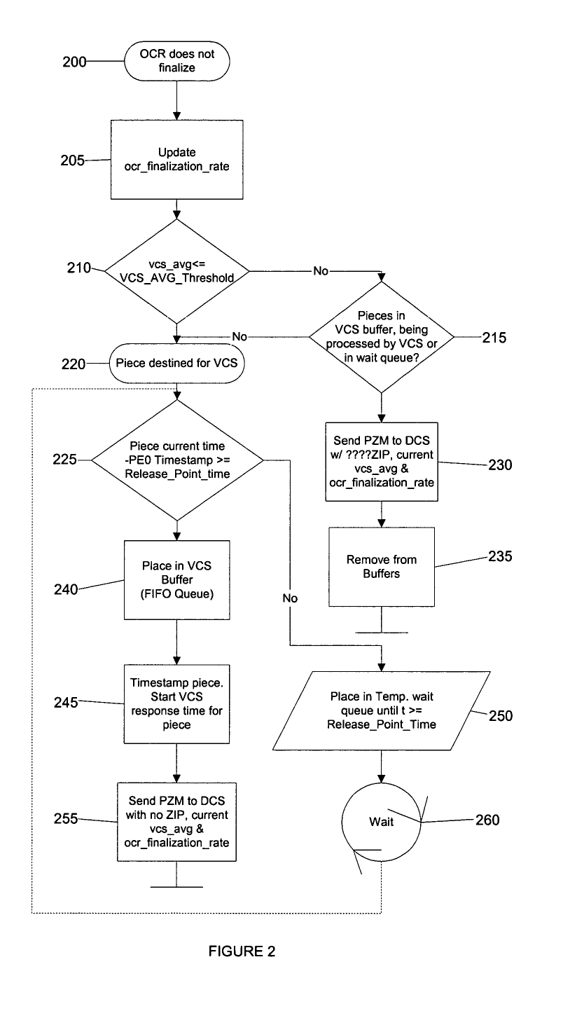

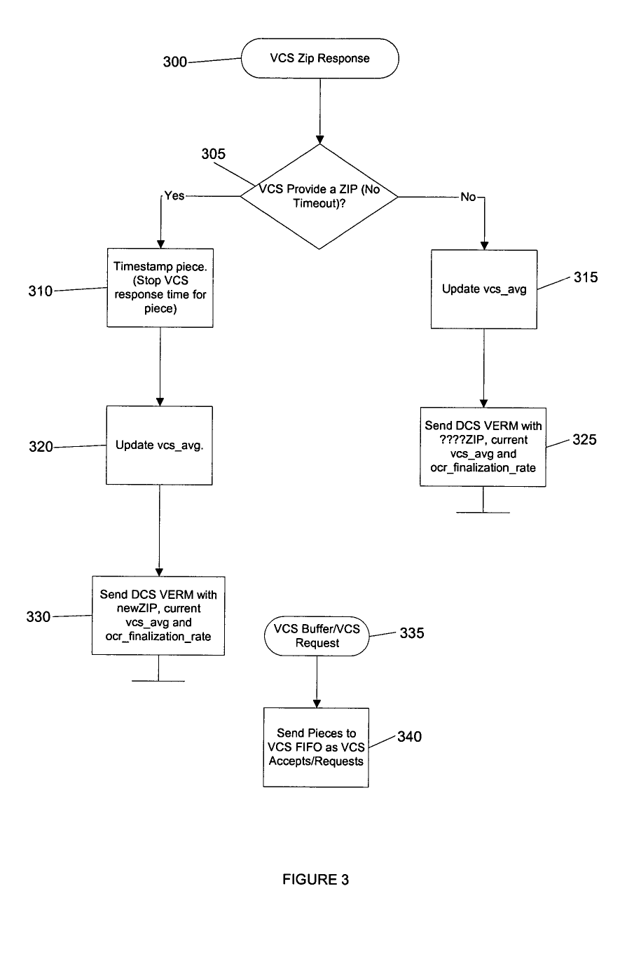

FIG. 2 is a flow diagram illustrating steps of a methodology for allocating video coding resources in accordance with an exemplary implementation of the invention. FIG. 2 (and FIG. 3) may equally represent a high level block diagram of the system of the invention. The steps of FIG. 2 (and FIG. 3) may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network.

A methodology in accordance with the invention is triggered when information required for handling is not automatically read or scanned from an article. By way of example, in step 200, a BCR/OCR system of a mail sorting system may fail to resolve a ZIP code on a mail piece. Those skilled in the art will appreciate that a methodology in accordance with the invention is readily applicable to articles other than mail, to information other than addresses and zip codes and to article handling operations other than sorting.

Performance of the BCR/OCR system may be monitored to reveal potential problems with either the BCR/OCR systems or the articles. In an exemplary implementation, the percentage of resolved articles from the last (i.e., most recent) one hundred articles (or some other determined amount of articles) is computed and updated. In step 205, a scanning finalization rate (ocr_finalization_rate) provides a means for determining how well the BCR/OCR systems have been in resolving information from processed articles.

Next, a measurement of recent performance of the video coding system is compared with a time allowed for video coding. In step 210, vcs_avg is a weighted average response time, i.e., weighted average time required for video coding operations to complete. An exemplary calculation of vcs_avg is discussed more fully below. Completion occurs when an article is resolved or times out. Unresolved articles may be directed to a manual handling station or to a sort bin for unresolved articles. VCS_AVG_THRESHOLD can be a variable or a constant. The system should allow a reasonable amount of time for video coding operations to complete, which can vary from 1 minute to a few minutes or more, depending upon the system and video coding capabilities.

If a current weighted average response time (vcs_avg) is less than or equal to the threshold response time threshold, i.e., VCS_AVG_THRESHOLD, then the article is destined for the video coding system, as in step 220. By way of example, the threshold response time may correspond to the time allowed until a timeout. In such case, an image of the unresolved information will be sent to a buffer (i.e., a video coding buffer) operatively coupled to an operator input station 122. An operator may then review the image on a display monitor 126 and input the correct information using an input device 128.

If the current weighted average response time (vcs_avg) exceeds VCS_AVG_THRESHOLD, then the article may be destined for reprocessing, a sort bin for unresolved articles or a manual handling and coding station. However, in an exemplary embodiment, an additional intermediate step is performed before an article is so destined. Such a step entails determining if the video coding system is busy, as in step 215. For example, if image data for unresolved articles are in the buffer, images are being processed by the video coding system, or images are in a wait queue (assuming a wait queue exists) for processing, then the video coding system is busy. Otherwise, the video coding system is not busy and it can probably accommodate an unresolved article. In such a case, the article is destined for the video coding system, as in step 220.

If the video coding system is busy, as determined in step 215, then the unresolved article will not be destined for the video coding system. Instead, an “unresolved” message will be sent to the article handling system (e.g., an unknown package zip code [????ZIP] message [PZM] is sent to a data collection system [DCS] of a mail sorter), as in step 230. Additionally, a current weighted average response time (vcs_avg) and an updated scanning finalization rate (ocr_finalization_rate) are provided to the article handling system, as in step 230. Next in step 235, any images of the unresolved information are preferably removed from buffers, so that the unresolved article no longer consumes video coding resources.

If an article is destined for the video coding system, as in step 220, an intermediate step may be performed before allocating video coding resources. For example, the system may wait until the article reaches a determined point before allocating video coding resources, as in step 225. If the difference between the piece current time (e.g., based on a current timestamp corresponding to the article [Piece Current Time]) and a previous reference timestamp (e.g., a photo eye 0 timestamp [PE0 Timestamp]) is greater than or equal to a determined release point time [Release_Point_Time], then video coding resources may be allocated and control proceeds to step 240. However, if (for example) the difference does not at least equal the determined release point time, then video coding resources should not yet be allocated for that article. Instead, the unresolved image should be placed in a wait queue until the difference at least equals the determined release point time (i.e., a release event occurs), or a timeout is reached, as in steps 250 and 260. An alternative release event may involve detecting that an article has passed a determined point in the transport path. Upon a timeout, the unresolved image may be removed from the queue. Thus, if (for example) an unresolved article is lost or damaged before it reaches the determined point, then video coding resources should not be wasted for that piece, even if it seems that video coding resources are available.

Assuming the condition in step 225 is satisfied (i.e., the difference between Piece Current Time and photo eye 0 timestamp is greater than or equal to Release_Point_Time), then image data for the unresolved article is placed in a video coding system buffer, as in step 240. The system may handle buffered images on a first-in first-out (FIFO) basis; although other bases such as a prioritized basis and a last-in first-out (LIFO) basis also come within the scope of the invention.

Next, the buffered article is timestamped, as in step 245. This may be accomplished by associating a timestamp with the buffered image data or otherwise associating a timestamp with the unresolved article. The timestamp enables a determination of how long the video coding process takes. This information is used to determine a weighted average response time (vcs_avg) as discussed more fully below.

In an implementation, the article handling system is informed that the article awaits video encoding, for example, as in step 255 by providing an unresolved package zip code [%%%% ZIP] message [PZM] to a data collection system [DCS] of a mail sorter. Additionally, a current weighted average response time (vcs_avg) and an updated scanning finalization rate (ocr_finalization_rate) may be provided to the article handling system, as in step 255.

Referring now to FIG. 3, a flow diagram illustrates steps of a video encoding response process in accordance with an exemplary implementation of the invention. The process is invoked when unresolved image data is buffered, such as in step 240. The video coding system response 300 will be either the resolved information or a timeout, as in step 305.

If the information is resolved, the article is then timestamped as in step 310. This timestamp along with the timestamp provided according to step 245 enable a determination of how long the video coding process took for the article. This information is used to determine a weighted average response time (vcs_avg) as discussed more fully below.

In step 320, an updated weighted average response time (vcs_avg) is computed. In an exemplary implementation, the following equation is used to determine an updated weighted average response time (vcs_avg) if the information is resolved via video coding.

$${vcs\_avg}_{n} = \frac{( {vcs\_avg}_{n - 1} \times VCS\_AVG \_WEIGHT ) + {t}_{response}}{VCS\_AVG \_WEIGHT + 1} \qquad Equation 1$$

where:

vcs_avgₙ is the updated weighted average response time,

vcs_avgₙ₋₁ is the preceding weighted average response time,

VCS_AVG_WEIGHT is a configurable weight factor (e.g., 100), and

tᵣₑₛₚₒₙₛₑ is the time from the timestamp in step 245 to the timestamp in step 310, representing how long the video coding process took for this article.

The weighted average response time represents an estimated time for video coding. It provides an indication of how long video coding has taken recently, based upon a previous weighted average response time and a response time for the current article. This estimate is updated with each video coding response. While an estimated time for video coding based on a weighted average response time according to Equation 1 is one implementation for resolved articles, those skilled in the art will appreciated that an unweighted average, different equations for computing weighted averages and samples, or the like, may be applied without departing from the scope of the invention, irrespective of whether or not the different equations may be reduced to Equation 1, are based upon Equation 1, or are substantially similar to Equation 1. After computing an updated weighted average response time (vcs_avg) according to step 320, the article handling system is provided a video encoding result message (VERM) with a resolved zip code [new ZIP], the updated weighted average response time (vcs_avg) and an updated scanning finalization rate (ocr_finalization_rate), as in step 330.

Information may be considered resolved even if a video coding operator determines that the information in the video display is unintelligible. In such a case, the so called “resolved” information (e.g., zip code) may correspond to an unresolved sorting bin or a manual handling and processing station. If the information is not resolved in a timely manner (i.e., before a timeout), an updated weighted average response time (vcs_avg) is computed, as in step 315. However, an actual response time will not be available and, therefore, is not used in the equation. Instead, a threshold response time (VCS_AVG_THRESHOLD) is used. By way of example, the threshold response time may correspond to the time allowed until a timeout. In an implementation, the following equation is used to determine an updated weighted average response time (vcs_avg) if the information is not resolved via video coding.

$${vcs\_avg}_{n} = \frac{( {vcs\_avg}_{n - 1} \times VCS\_AVG \_WEIGHT ) + VCS\_AVG \_THRESHOLD + 1 }{VCS\_AVG \_WEIGHT + 1} \qquad Equation 2$$

where:

vcs_avgₙ is the updated weighted average response time,

vcs_avgₙ₋₁ is the preceding weighted average response time,

VCS_AVG_WEIGHT is a configurable weight factor (e.g., 100), and

VCS_AVG_THRESHOLD is a determined threshold response time for timed-out articles.

The threshold response time (VCS_AVG_THRESHOLD) according to Equation 2 has a tendency to increase the weighted average response time. Again, the weighted average response time represents an estimated time for video coding. While the weighted average response time according to Equation 2 is one implementation for timed-out articles, those skilled in the art will appreciate that an unweighted average, different equations for computing weighted averages and samples, or the like, may be applied without departing from the scope of the invention, irrespective of whether or not the different equations may be reduced to Equation 2, are based upon Equation 2, or are substantially similar to Equation 2.

After computing an updated weighted average response time (vcs_avg) according to step 320, the article handling system is provided a video encoding result message (VERM) with an unresolved zip code [????ZIP], the updated weighted average response time (vcs_avg), and an updated scanning finalization rate (ocr_finalization_rate), as in step 325.

Now referring to steps 335 and 340, the video coding system buffer is preferably managed on a first-in first-out (FIFO) basis as the video coding system accepts and requests image data for unresolved articles. Other bases such as a prioritized basis and a last-in first-out (LIFO) basis also come within the scope of the invention.

While the invention has been described in terms of various embodiments and implementations, those skilled in the art will recognize that the invention can be practiced with modification within the spirit and scope of the appended claims.

We claim the following:

1. A method for using video encoding resources in an article handling system, the method comprising steps of:
determining whether an estimated time for video coding exceeds a determined threshold, if an imaging device does not resolve information needed for handling an article, and
sending image data for unresolved information to a video coding station if the estimated time for video coding does not exceed the determined threshold.

2. The method of claim 1, further comprising a step of sending image data for the unresolved information to a video coding buffer before the image data is sent to the video coding station.

3. The method of claim 2, further comprising steps of:
determining whether the video coding station is busy if the estimated time for video coding exceeds the determined threshold, and
sending image data for the unresolved information to the video coding buffer if the video coding station is not busy.

4. The method of claim 3, wherein if the video coding station is busy, then the image data for the unresolved information is not sent to the video coding buffer.

5. The method of claim 4, wherein the estimated time for video coding is comprised of a weighted average response time.

6. The method of claim 5, wherein, if the image data for the unresolved information is sent to the video coding station before a timeout occurs, then the weighted average response time is computed according to the following equation:
$${vcs\_avg}_{n} = \frac{( {vcs\_avg}_{n - 1} \times VCS\_AVG \_WEIGHT ) + {t}_{response}}{VCS\_AVG \_WEIGHT + 1}$$
where:
vcs_avgₙ is the weighted average response time,
vcs_avgₙ₋₁ is a preceding weighted average response time,
VCS_AVG_WEIGHT is a configurable weight factor, and
tᵣₑₛₚₒₙₛₑ is the amount of time from the time the image data for the unresolved information is sent to the video coding buffer until the time the information is resolved at the video coding station.

7. The method of claim 5, wherein, if the image data for the unresolved information is not sent to the video coding station before a timeout occurs, then the weighted average response time is computed according to the following equation:
$${vcs\_avg}_{n} = \frac{( {vcs\_avg}_{n - 1} \times VCS\_AVG \_WEIGHT ) + VCS\_AVG \_THRESHOLD + 1 }{VCS\_AVG \_WEIGHT + 1}$$
where:
vcs_avgₙ is the weighted average response time,
vcs_avgₙ₋₁ is a preceding weighted average response time,
VCS_AVG_WEIGHT is a configurable weight factor, and
VCS_AVG_THRESHOLD is a determined threshold response time for timed-out articles.

8. The method of claim 7, further including a step of temporarily storing image data for the unresolved information in a wait queue before sending such image data to the video coding buffer.

9. The method of claim 8, further including a step of providing a video encoding result message, the video encoding result message including resolved information needed for handling the article in the article handling system, if the image data for the unresolved information is sent to the video coding station before a timeout occurs and the information is resolved, the article being a mail piece.

10. A method for using available video encoding resources in an article handling system, the method comprising steps of:
determining whether an estimated time for video coding exceeds a determined threshold, if the imaging device does not resolve information needed for handling an article, and
sending image data for the unresolved information to a wait queue until a determined release event or timeout occurs if the estimated time for video coding does not exceed the determined threshold,
sending the image data for the unresolved information from the wait queue to the video coding buffer if a determined release event occurs;
if the estimated time for video coding exceeds the determined threshold, then determining whether the video coding station is busy, and if the video coding station is not busy, then sending image data for the unresolved information to the wait queue until a determined release event or timeout occurs, and if the determined release event occurs, then sending the image data for the unresolved information from the wait queue to the video coding buffer; and if the video coding station is busy, then not sending the image data for the unresolved information to the video coding buffer.

11. The method of claim 10, wherein, if the image data for the unresolved information is sent from the video coding buffer to the video coding station before a timeout occurs, then the weighted average response time is computed according to the following equation:
$${vcs\_avg}_{n} = \frac{( {vcs\_avg}_{n - 1} \times VCS\_AVG \_WEIGHT ) + {t}_{response}}{VCS\_AVG \_WEIGHT + 1}$$
where:
vcs_avgₙ is the weighted average response time,
vcs_avgₙ₋₁ is a preceding weighted average response time,
VCS_AVG_WEIGHT is a configurable weight factor, and
tᵣₑₛₚₒₙₛₑ is the amount of time from the time the image data for the unresolved information is sent to the video coding buffer until the time the information is resolved at the video coding station.

12. The method of claim 11, wherein, if the image data for the unresolved information is not sent from the video coding buffer to the video coding station before a timeout occurs, then the weighted average response time is computed according to the following equation:
$${vcs\_avg}_{n} = \frac{( {vcs\_avg}_{n - 1} \times VCS\_AVG \_WEIGHT ) + VCS\_AVG \_THRESHOLD + 1 }{VCS\_AVG \_WEIGHT + 1}$$
where:
vcs_avgₙ is the weighted average response time, vcs_avgₙ₋₁ is a preceding weighted average response time,
VCS_AVG_WEIGHT is a configurable weight factor, and
VCS_AVG_THRESHOLD is a determined threshold response time for timed-out articles.

13. The method of claim 12, further including a step of providing a video encoding result message, the video encoding result message including resolved information needed for handling the article in the article handling system, if the image data for the unresolved information is sent to the video coding station before a timeout occurs and the information is resolved.

14. The method of claim 10, wherein the article is mail pieces.

15. A system for using available video encoding resources for handling articles in an article handling system, comprising:
an imaging device which produces image data representative of information on an article,
a video coding station which manually enters unresolved information, and
at least one programmable processor operatively coupled to the imaging device and the video coding station,
wherein at least one of the at least one programmable processor is programmed to determine whether an estimated time for video coding exceeds a determined threshold if the imaging device does not resolve information needed for handling an article, and sending image data for the unresolved information to the video coding station if the estimated time for video coding does not exceed the determined threshold.

16. The system of claim 15, further including a video coding buffer for buffering image data before the image data is sent to the video coding station.

17. The system of claim 16, wherein at least one of the at least one programmable processor determines whether the video coding station is busy if the estimated time for video coding exceeds the determined threshold, and sends image data for the unresolved information to the video coding buffer if the video coding station is not busy.

18. The system of claim 17, wherein none of the at least one programmable processor sends image data for the unresolved information to the video coding buffer if the estimated time for video coding exceeds the determined threshold and the video coding station is busy.

19. The system of claim 16, further including a wait queue for temporarily storing image data for the unresolved information before such image data is sent to the video coding buffer.

20. The system of claim 15, wherein at least one of the at least one programmable processor determines the estimated time for video coding based on a weighted average response time.
